(19) United States
(12) Patent Application Publication
(10) Pub. No.: US 2015/0077216 A1
(43) Pub. Date: Mar. 19, 2015

(54) High Voltage Resistor And Methods Of Fabrication

(71) Applicant: Guillaume Frerejean, New York, NY (US)

(72) Inventor: Guillaume Frerejean, New York, NY (US)

(73) Assignee: Schlumberger Technology Corporation, Sugar Land, TX (US)

(21) Appl. No.: 14/370,236

(22) PCT Filed: Jan. 4, 2012
(86) PCT No.: PCT/US11/54152

§ 371 Date: Nov. 19, 2014

(51) Int. Cl. H01C 7/22; H01C 17/30; H01C 17/24; H01C 17/242; H01C 1/012; H01C 17/06

(52) U.S. Cl. CPC H01C 7/22; H01C 1/012; H01C 17/06; H01C 17/2416; H01C 17/242; H01C 17/30
USPC 338/285; 216/16

(57) ABSTRACT

A high voltage resistor includes a ceramic substrate having a surface and defining a groove, and a resistive film deposited in the groove such that the resistive film is recessed relative to the surface of the ceramic substrate.

### BACKGROUND OF THE INVENTION

1. Field of the Invention

This invention relates broadly to high voltage resistors and methods for fabricating the same. More particularly, this invention relates to a high voltage resistors which are useful in conjunction with high voltage power supplies such as may be used in conjunction with X-ray tubes, neutron generators, photo-multiplier tubes and the like, although the invention is not limited thereto.

2. State of the Art

High voltage resistors are well known in the art. A high voltage (HV) resistor is a resistor which is typically on the order of 100 mega-ohms (Mohms) or more. HV resistors on the order of giga-ohms (Gohms) are known in the art and are available from companies such as Vishay Intertechnology, Inc. of Malvern, Pa., Ohmcraft-Micropen Technologies Corporation of Honeoye Falls, N.Y., and Caddock Electronics of Riverside, Calif.

A standard high voltage resistor utilizes a ceramic substrate such as alumina on top of which is laid a film of resistive material in a serpentine or patterned fashion. The HV resistor may be arranged in a cylindrical or a planar fashion. Different techniques are known for laying the film down on the substrate. If a sputtering process is used, the resulting resistor is called a “thin film” resistor as the thickness of the film is controllable by the length of the sputtering process. If a screen and stencil printing process is utilized, the resulting resistor is called a “thick film” resistor. Typically, the film is selected from a ceramic-metal (cermet) material such as bismuth iridate (Bi2Ir2O7), ruthenium dioxide (RuO2), iridium dioxide (IrO2), etc. The material of the film, the thickness and width of the film, and the length of the path determine the resistance of the resistor. HV resistors typically operate at a voltage/inch ratio of 10 kV per inch.

HV resistors fail over time due to the effects of high electrical stress, high temperature, physical damage to the film, or a combination of factors. Sometimes surface tracking (charge movement) between loops of the path or the trapping of contaminants between loops of the path causes a short circuit to develop.

### SUMMARY OF THE INVENTION

In accord with one embodiment of the invention, a high voltage resistor is provided and comprises a ceramic substrate having a surface and defining a groove, and a resistive film deposited in the groove such that the resistive film is recessed relative to said surface of said ceramic substrate.

According to one aspect of the invention, the resistive film is placed in the groove of the ceramic substrate by thick-film micro-pen technology.

According to one embodiment of the invention the ceramic substrate of the HV resistor is planar. According to another embodiment of the invention, the ceramic substrate is cylindrical. According to another embodiment, the ceramic substrate can take any desired shape.

According to a further embodiment of the invention, the ceramic substrate is made from alumina According to yet another embodiment of the invention, the resistive film is made from a flowable ceramic-metal (“cermet”) paste which is sintered or cured in place.

According to another aspect of the invention, where a flat ceramic substrate is utilized, the groove in the ceramic is laid out in a serpentine or winding format.

According to a further aspect of the invention, where a cylindrical substrate is utilized, the groove in the ceramic is laid out helically.

Objects and advantages of the invention will become apparent to those skilled in the art upon reference to the detailed description taken in conjunction with the provided figures.

### BRIEF DESCRIPTION OF THE DRAWINGS

FIG. 1 is top view of a first embodiment of a high voltage resistor according to the invention.

FIG. 1a is a cross-sectional view through A-A of FIG. 1.

FIG. 1b is a cross-sectional view through B-B of FIG. 1.

FIG. 2 is a top view of a second embodiment of a high voltage resistor according to the invention.

FIG. 2a is a cross-sectional view through A-A of FIG. 2.

FIG. 3 is a perspective view of a third embodiment of a high voltage resistor according to the invention.

### DETAILED DESCRIPTION OF THE PREFERRED EMBODIMENTS

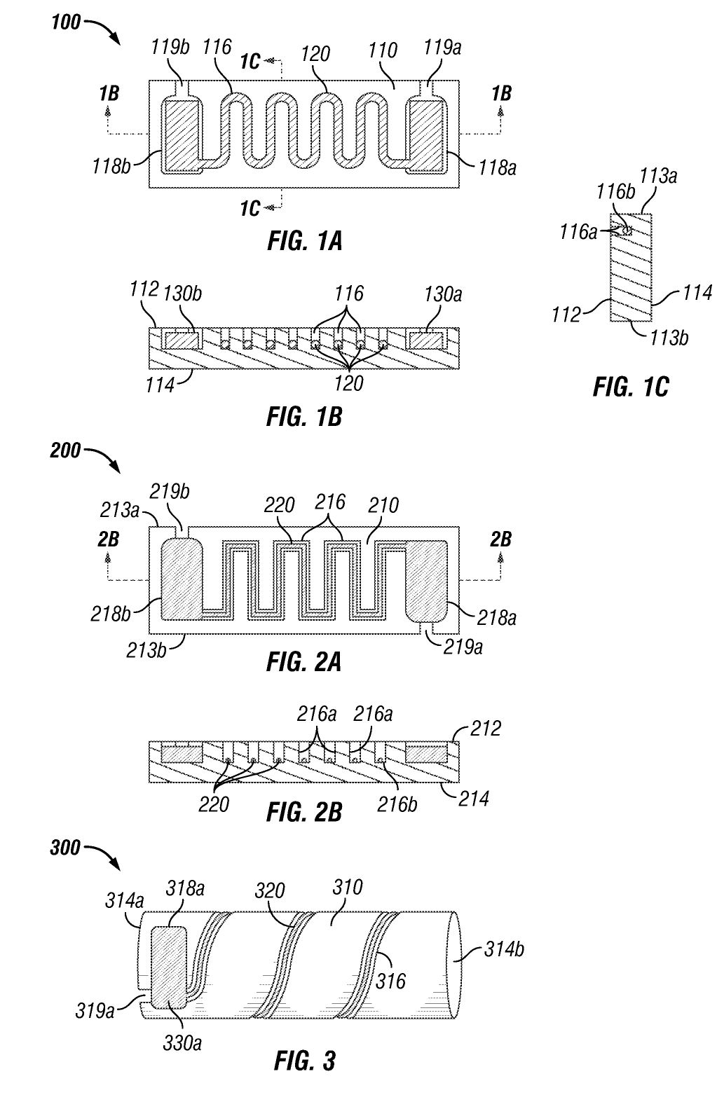

Turning to FIGS. 1, 1a, and 1b, a first embodiment of the invention is seen. A high voltage resistor 100 includes a substrate 110 and a resistive film 120. The substrate 110 is shown to have a top surface 112, side surfaces 113a, 113b, a bottom surface 114, and a groove 116 which is defined in the substrate 110. The groove 116 is shown to be serpentine or winding with curved areas and straight areas, although it may be laid out different fashions with only straight areas or only curved areas. The groove 116 is defined by side wall(s) 116a, and a bottom wall 116b. At each of the ends of the groove 116, the substrate defines well areas 118a, 118b. Each well area may include one or more extensions 119a, 119b which extends to the side surface of the substrate. The resistive film 120 is shown located inside the groove and in contact with the side walls 116a and the bottom wall 116b and recessed below the top surface 112 of the substrate 110. Conductive pads 130a, 130b are shown laid down inside of the wells 118a, 118b. The conductive pads are in electrical contact with the ends of the resistive film 120. The conductive pads are preferably recessed below the top surface 112 of the substrate, but, if desired may extend up to or beyond the top surface of the substrate. Electrical contact may be made to the pads 130a, 130b either via the sides 113a, 113b of the substrate through the extensions 119a, 119b of the wells 118a, 118b, or to the top of the pads.

The substrate 110 is preferably made from a relatively non-conductive ceramic material such as alumina. Other ceramic materials such as zirconia may be utilized. The substrate may be etched, subject to a laser cut, or otherwise treated according to well known techniques in order to form the groove.

The resistive film 120 is preferably selected from a ceramic-metal (cermet) material such as bismuth iridate (Bi2Ir2O7), ruthenium -oxide (RuO2), iridium-oxide (IrO2), depending upon the desired resistivity of the resistor, although other materials (cermet or otherwise) can be utilized. According to one embodiment of the invention, the resistive film is laid down as a flowable paste and cured in place, e.g., by sintering.

According to one aspect of the invention, the ceramic substrate 110 may be of any desired thickness. Typical substrate thicknesses are in the range of 0.5 mm to 5 mm. According to another aspect of the invention, the groove is typically at least 200 microns wide, and preferably less than 500 microns wide, although other widths may be utilized depending on the resistive film width. According to a further aspect of the invention, the groove is preferably at least 5 microns deep, and more preferably at least 20 microns deep, although other depths may be utilized. Regardless of depth, the resistive film is preferably recessed at least 5 microns from the top surface 112 of the substrate 110. By recessing the film relative to the top surface 112 of the substrate, it is believed that, all other factors being constant, the resulting HV resistor will have a longer effective life than prior art HV resistors where the resistive films are laid on the top surface of the substrate. Alternatively, the resulting HV resistor may be able to be used in higher voltage situations than prior art HV resistors, or may provide the same desired resistance with a smaller footprint than prior art HV resistors.

According to a preferred embodiment of the invention, the resistive film 120 is laid down in the groove of 116 of the substrate 110 utilizing a direct writing technique. One direct writing technique utilizes a micro-pen having a nozzle through which a flowable paste is deposited. (See, “Cai, Zhixiang et al., “Laser sintering of thick-film PTC thermistor paste deposited by micro-pen direct-write technology”: Microelectronic Engineering 86, pages 10-15 (2009). After laying the paste into the groove the paste is cured by subjecting the entire substrate to a high temperature in order to sinter the paste in place. Alternatively, a laser may be used to sinter the paste in the groove.

According to other embodiments of the invention, the resistive film is laid down in the groove using other desired techniques known in the art.

A second embodiment of the invention is seen in FIGS. 2 and 2a, where a high voltage resistor 200 includes a substrate 210 and a resistive film 220. The substrate 210 is shown to have a top surface 212, side surfaces 213a, 213b, a bottom surface 214, and a groove 216 which is defined in the substrate 210. The groove 216 is shown to be winding in a maze-like manner with only straight areas, although it may be laid out different fashions with only curved areas or in a serpentine manner. The groove 216 is defined by side wall(s) 216a, and a bottom wall 216b. At each of the ends of the groove 216, the substrate defines well areas 218a, 218b. Each well area may include one or more extensions 219a, 219b which extend to the side surface of the substrate. The resistive film 220 is shown located inside the groove 216, recessed from the top surface 212 of the substrate 210, in contact with the bottom wall 216b of the groove, but spaced from the side walls 216a of the groove. Conductive pads 130a, 130b are shown laid down inside of the wells 218a, 218b. The conductive pads are in electrical contact with the ends of the resistive film 220. The conductive pads are preferably recessed below the top surface 212 of the substrate, but, if desired may extend up to or beyond the top surface of the substrate. Electrical contact may be made to the pads 230a, 230b either via the sides 213a, 213b of the substrate through the extensions 219a, 219b of the wells 218a, 218b, or to the top of the pads.

By recessing the film 220 relative to the top surface 212 of the substrate, and by locating the film 220 in the groove 216 but spaced from the side walls 216a, it is believed that, all other factors being constant, the resulting HV resistor will have a longer effective life than prior art HV resistors. Alternatively, the resulting HV resistor may be able to be used in higher voltage situations, or may provide the same desired resistance with a smaller footprint than prior art HV resistors.

It is noted that aspects of the HV resistor 200 such as substrate material, film material, groove width and depth, and mechanisms for laying down the film material in the groove may be as described above with respect to HV resistor 100.

A third embodiment of the invention is seen in FIGS. 3, 3a and 3b where an HV resistor 300 is provided. HV resistor 300 includes a substrate 310 and a resistive film 320. The substrate 310 is shown to be cylindrical with an outer surface 312, end surfaces 314a, 314b and a groove 316 which is defined in the substrate 310. The groove 316 is shown to be a helical groove, although it could be arranged to be serpentine or winding as in the first two embodiments. The groove 316 is defined by side wall(s) 316a, and a bottom wall 316b. At each of the ends of the groove 316, the substrate defines well areas 318a (only one shown). Each well area may include one or more extensions 319a (only one shown) which extend to the end surface 314a, 314b of the substrate. The resistive film 320 is shown located inside the groove 316, recessed from the outer surface 312 of the substrate 310, in contact with the bottom wall 316b of the groove and the side walls 316a of the groove. If desired, the film 320 could be spaced from the side walls 316a of the groove. Conductive pads 330a (only one shown) are shown laid down inside of the wells 318a. The conductive pads are in electrical contact with the ends of the resistive film 320. The conductive pads are preferably recessed below the outer surface 312 of the substrate, but, if desired may extend up to or beyond the outer surface of the substrate. Electrical contact may be made to the pads 330a either via the ends 314a, 314b of the substrate through the extensions 319a of the wells 318a, or to the top of the pads.

By recessing the film 320 relative to the outer surface 312 of the substrate it is believed that, all other factors being constant, the resulting HV resistor will have a longer effective life than prior art HV resistors. Alternatively, the resulting HV resistor may be able to be used in higher voltage situations, or may provide the same desired resistance with a smaller footprint than prior art HV resistors.

It is noted that aspects of the HV resistor 300 such as substrate material, film material, groove width and depth, and mechanisms for laying down the film material in the groove may be as described above with respect to HV resistor 100.

The HV resistors 100, 200, 300 may be used in conjunction with high voltage and/or high temperature applications such as high voltage power supplies for X-ray tubes, neutron generators, photo-multiplier tubes and the like, although the invention is not limited thereto.

There have been described and illustrated herein several embodiments of a While particular geometries have been described for the ceramic substrate and groove, it will be appreciated that other geometries could be utilized. It will therefore be appreciated by those skilled in the art that yet other modifications could be made to the provided invention without deviating from its spirit and scope as claimed.

1. A high voltage resistor, comprising:
a) a ceramic substrate having a surface and defining a groove interrupting said surface; and
b) a resistive film deposited in said groove such that said resistive film is recessed relative to said surface of said ceramic substrate.

2. A high voltage resistor according to claim 1, wherein:
said ceramic is alumina.

3. A high voltage resistor according to claim 1, wherein:
said resistive film is formed from a ceramic-metal paste.

4. A high voltage resistor according to claim 1, wherein:
said surface is a flat surface.

5. A high voltage resistor according to claim 1, wherein:
said groove is winding or serpentine.

6. A high voltage resistor according to claim 1, wherein:
said surface is a rounded surface.

7. A high voltage resistor according to claim 6, wherein:
said groove is helical.

8. A high voltage resistor according to claim 1, wherein:
said ceramic substrate further defines respective wells at respective ends of said groove, and said resistor further comprises conductive pads located in said respective wells, said conductive pads in electrical connection with said resistive film.

9. A high voltage resistor according to claim 1, wherein:
said groove has side walls and a bottom wall, and said resistive film is in contact with said bottom wall.

10. A high voltage resistor according to claim 9, wherein:
said resistive film is in contact with said side walls of said groove.

11. (canceled)

12. (canceled)

13. (canceled)

14. A high voltage resistor according to claim 1, wherein:
said high voltage resistor has a resistance of at least 1 Gohm.

15. A method of manufacturing a high voltage resistor, comprising:
a) obtaining a ceramic substrate having a surface;
b) forming a groove in said ceramic substrate which interrupts said surface; and
c) forming a resistive film in said groove such that said resistive film is recessed relative to said surface of said ceramic substrate.

16. A method according to claim 15, wherein:
said forming a resistive film comprises directly writing said resistive film in said groove.

17. A method according to claim 16, wherein:
said directly writing comprises using a micro-pen to directly write a ceramic-metal material in said groove, and curing said ceramic-metal material to form said resistive film.

18. A method according to claim 17, wherein:
said curing comprises subjecting said ceramic-metal to sintering or a laser in order to cure said ceramic-metal material.

19. A method according to claim 16, wherein:
said forming a groove comprises etching said ceramic substrate.
